(19) United States
(12) Patent Application Publication
(10) Pub. No.: US 2008/0074879 A1
(43) Pub. Date: Mar. 27, 2008

(54) ILLUMINATION DEVICE

(75) Inventors: Wu-Cheng Kuo, Tainan City (TW); Ya-Hui Chiang, Taoyuan County (TW); Bing-Ru Chen, Pingtung County (TW); Hung-Lieh Hu, Hsinchu City (TW); Kuo-Hsiang Chen, Taipei County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/562,949

(22) Filed: Nov. 22, 2006

(30) Foreign Application Priority Data
Sep. 27, 2006 (TW) TW95135748

(51) Int. Cl. F21S 8/00

(52) U.S. Cl. 362/268

(57) ABSTRACT

An illumination device includes a light source generating initial light beams, a lens assembly disposed on an axis, and a reflector comprising a reflecting surface. The initial light beams include a first and second reference light beams traveling along a first and second positions, respectively. The first reference light beam passes through the lens assembly to form a first predetermined light beam traveling away from the light source. A first angle is substantially formed between the first position and the axis. The second reference light beam is reflected by the reflective surface to form a second predetermined light beam traveling away from the light source. A second angle is formed between the first and second positions. The first angle is less than or equal to the second angle. The initial light beams are guided by the lens assembly and the reflector to emit the light beams in a projecting mode.

### BACKGROUND OF THE INVENTION

1. Field of the Invention

The invention relates to a projection illumination device, and in more particular to a projection illumination device utilizing a lens assembly and a reflector to project light beams.

2. Description of the Related Art

U.S. Pat. No. 6,558,032 discloses a LED lighting equipment for vehicle. In FIG. 1, the LED lighting equipment comprises a LED lighting equipment 1′ comprising a LED lamp 2′, a reflection surface of hyperboloid 4′ having two focuses f1 and f2, and a reflection surface of paraboloid of revolution 5′. Light beams reflected by the reflection surface 4′ are emitted outwardly and centrally from the focus f2. The focus f2 of the reflection surface 4′ and the focus of the reflection surface 5′ are overlapped. The light beams reflected by the reflection surface 5′ travel to the remote ahead of the reflection surface 5′.

### BRIEF SUMMARY OF THE INVENTION

The invention provides a projection illumination device capable of emitting light in a projecting mode such as distant-light mode. The projection illumination device of the invention comprises a light source, a lens assembly and a reflector. The light source generates a plurality of initial light beams. The initial light beams comprise a first reference light beam traveling in a first direction directed from the light source to the lens assembly and a second reference light beam traveling in a second direction directed from the light source to the reflector. The lens assembly is disposed on an axis. The first reference light beam traveling in the first direction passes through the lens assembly to form a first predetermined light beam traveling away from the light source and a first angle is substantially formed between the first direction and the axis. The reflector comprises a reflective surface. The second reference light beam traveling in the second direction is reflected by the reflecting surface of the reflector to form a second predetermined light beam traveling away from the light source. A second angle is formed substantially between the second direction and the first direction. The first angle is less than or equal to the second angle. The initial light beams are guided by the lens assembly and the reflector to emit light in the projecting mode.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional vehicle light;

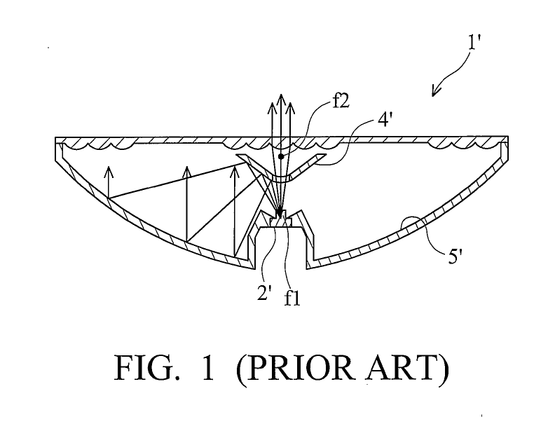

FIG. 2A is a schematic view of a projection illumination device (E1) of a first embodiment of the invention, wherein the projection illumination device (E1) is in an operating mode;

FIG. 2B is a schematic view of the projection illumination device (E1) in an operating mode;

FIG. 3 is a schematic view of the projection illumination device (E1) in an operating mode;

FIG. 4 is a schematic view of a projecting mode (M1) formed by the projection illumination device (E1);

FIG. 5 is a schematic view of a varied example (E1a) of the projection illumination device (E1) of the invention;

FIG. 6 is a schematic view of a projection illumination device (E2) of a second embodiment of the invention;

FIG. 7A is a schematic view of the projection illumination device (E2) in an operating mode;

FIG. 7B is a schematic view of the projection illumination device (E2) in an operating mode;

FIG. 8 is a schematic view of the projection illumination device (E2) in an operating mode; and

FIG. 9 is a schematic view of a projecting mode (M2) formed by the projection illumination device (E1).

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

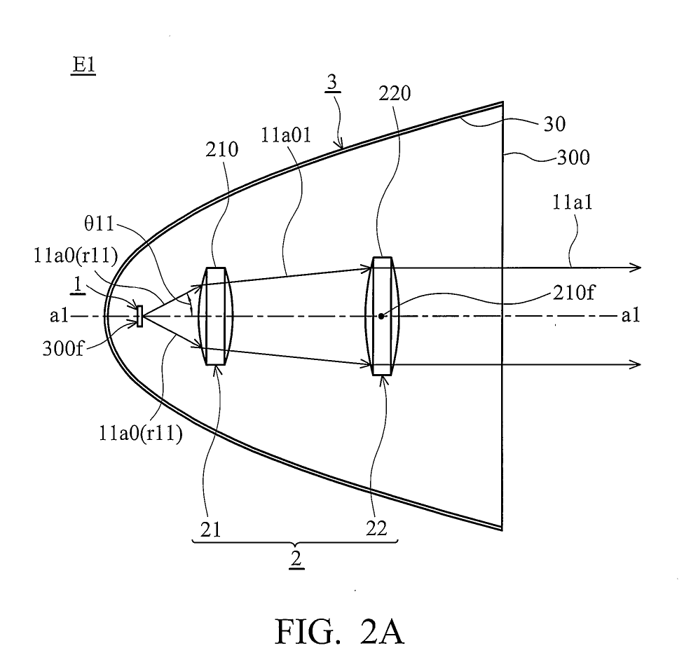

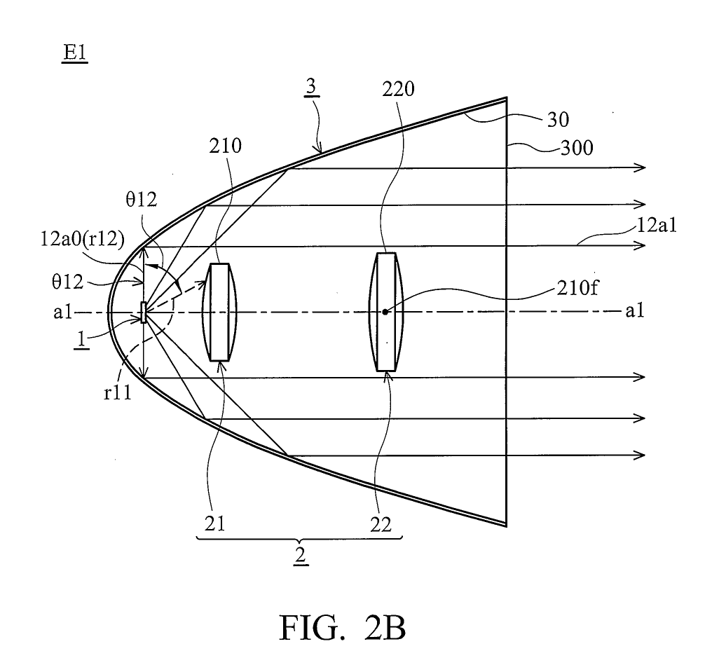

In FIG. 2A, a projection illumination device E1 of a first embodiment of the invention situated in an operating mode comprises a light source 1, a lens assembly 2 and a reflector 3. The light source 1 and the lens assembly 2 disposed in the reflector 3 are spaced apart from each other. A plurality of initial light beams generated from the light source 1 are guided by the lens assembly 2 and the reflector 3 to form a desired projecting mode, e.g. distant-light mode, or other regulated light source distribution.

The reflector 3 comprises a light-emitting opening 300 and a conical reflective surface 30 having a main focus 300f located at an axis a1-a1. The light source 1 is located at the main focus 300f of the reflective surface 30 of the reflector 3, and the shape of the light-emitting opening 300 is dependent on the curvature of the reflective surface 30. In this embodiment, the reflective surface 30 is a parabolic surface and the light-emitting opening 300 is symmetrical. The reflective surface 30 can be an elliptical or hyperbolic surface.

The lens assembly 2 comprises a first lens unit 21 and a second lens unit 22. The first lens unit 21 has a first outer end 210 and a first focus 210f. The second lens unit 22 substantially located at the first focus 210f of the first lens unit 21 has a second outer end 220. The first and second lens units 21 and 22 disposed on the axis a1-a1 are spaced from each other, and the first lens unit 21 is located between the light source 1 and the second lens unit 22. The first lens unit 21 and the second lens unit 22 sequentially guide the initial light beams 11a0 of the light source 1 to form a first predetermined light beam 11a1 traveling away from the light source 1.

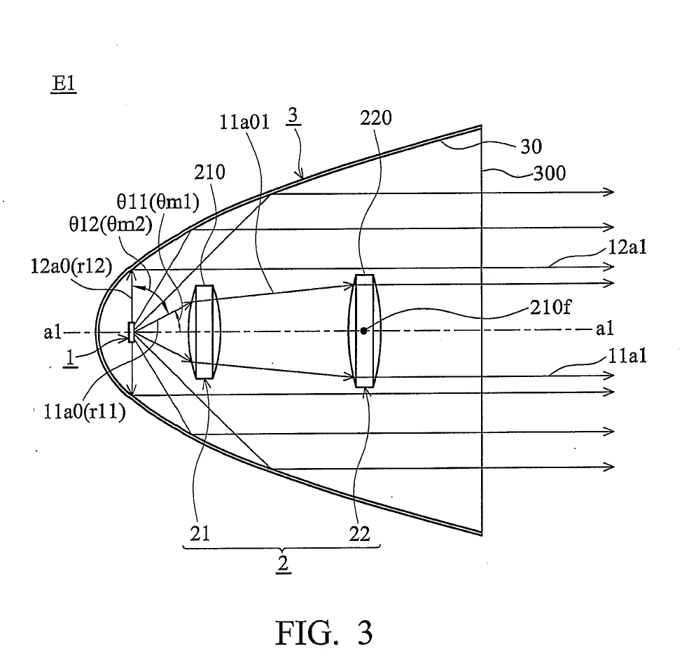

With respect to an effective area of the first lens unit 21, a conical initial light beams 11a0 of the light source 1 received by the first lens unit 21 are guided to the second lens unit 22. The outer conical surface of the conical initial light beams 11a0 is defined as a first position r11, and a first angle θ11 is substantially formed between the first position r11 and the axis a1-a1. The initial light beams 11a0 located on the first position r11 are defined as a first reference light beam 11a0(r11) traveling in a first direction d11 directed from the light source 1 to the first lens unit 21 of the lens assembly 3. That is to say, the first angle θ11 is a first boundary effective angle θm1 (shown in FIG. 3) for the lens assembly 2 capable of guiding the initial light beams 11a0 of the light source 1 with respect to the axis a1-a1.

The initial light beams 1a0 located inside the first position r11 and the first reference light beam 11a0(r11) located on the first position r11, i.e., the initial light beams 11a0 located in the range of the first angle θ11 with respect to the axis a1-a1, are converted into a plurality of refracted light beams 11a01 by the first lens unit 21, and the refracted light beams 11a01 guided by the second lens unit 22 forms the first predetermined light beam 11a1 traveling away from the light source 1.

In FIG. 2B, to specify the distribution of the light beams reflected by the reflective surface 30 of the reflector 3, the initial light beams 11a0 located within the first position r11 guided by the first and second lens units 21 and 22 of the lens assembly 2 and the first predetermined light beam 11a1 formed by the first and second lens units 21 and 22 are omitted.

The initial light beams 12a0 of the light source 1 perpendicular to the axis a1-a1 is reflected by the reflective surface 30 of the reflector 3 to form a second predetermined light beam 12a1 traveling away from the light source 1. The second predetermined light beam 12a1 substantially has a round structure defined as a second position or an effective position r12, and a second angle θ12 is substantially formed between the second position r12 and the first position r11. The initial light beams 12a0 located on the second position r12 are defined as a second reference light beam 12a0(r12) traveling along the second position r12. In this embodiment, the first angle θ11 is less than or equal to the second angle θ12, and the sum of the first angle θ11 and the second angle θ12 is substantially equal to 90 degrees. The second reference light beam 12a0(r12) has an initial direction substantially perpendicular to the axis a1-a1.

The second angle θ12 is a second boundary effective angle θm2 for the reflective surface 30 of the reflector 3 capable of guiding the initial light beams 12a0 of the light source 1 not passing through lens assembly 2 with respect to the axis a1-a1. The first angle θ11 is less than or equal to 45 degrees or ranging from about 0 to 30 degrees. The second angle θ12 is less than 90 degrees or ranging from about 20 to 90 degrees.

The initial light beams 11a0 and 12a0, the first reference light beam 11a0(r11) and the second reference light beam 12a0(r12) substantially travel along the same direction.

Note that the second reference light beam 12a0(r12) traveling in the second direction r12 is not interfered by the first and second outer ends 210 and 220 of the lens assembly 2. That is to say, part of the second predetermined light beam 12a1 formed by the initial light beams 12a0 moving along the second position r12 encloses the lens assembly 2 therein, so that the structure of the first and second lens 21 and 22 of the lens assembly 2 is limited within the light paths formed by the second reference light beam 12a0(r12).

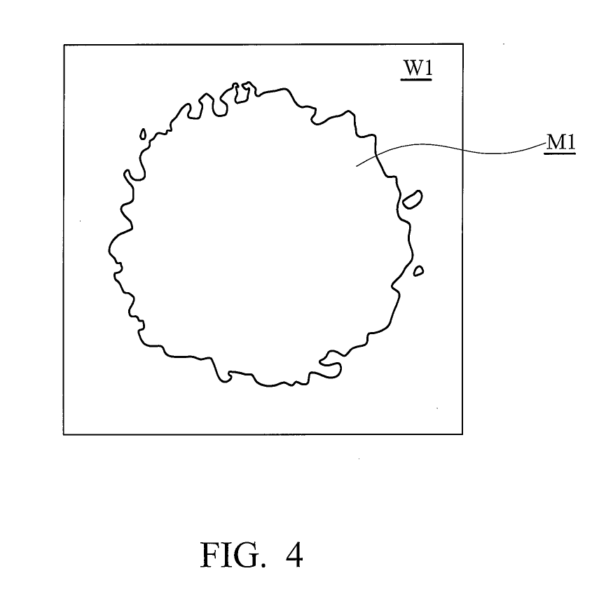

In FIG. 3, the initial light beams 11a0 and 12a0 generated from the light source 1 are guided by the lens assembly 2 and the reflector 3 to emit light in a desired projecting mode M1 (shown in FIG. 4) at a desired distance in front of the projection illumination device E1 according to related regulations. In this embodiment, the projecting mode M1 is a distant-light mode formed on a plane W1, at a predetermined distance, e.g., 25 meters in front of the projection illumination device E1.

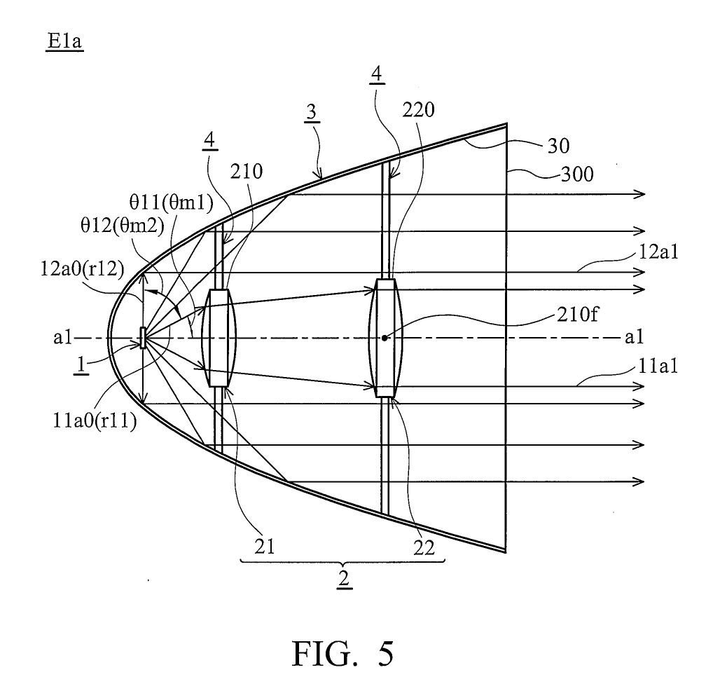

In FIG. 5, a projection illumination device E1a is a varied example of the illumination device E1. The illumination device E1a differs from the projection illumination device E1 in that the projection illumination device E1a further comprises at least one connecting portion 4 disposed between the lens assembly 2 and the reflector 3, i.e., the lens assembly 2 is positioned on the reflector 3 via the connecting portion 4. In the projection illumination device E1a, two connecting portions 4 are applied to be disposed between the reflector 3 and the first lens unit 21 and between the reflector 3 and the second lens unit 22, respectively. The installation of the connecting portions 4 does not affect projecting mode M1. In other embodiments, the first and second lens units 21 and 22 of the lens assembly 2 are spherical or non-spherical lenses, and the reflective surface 30 of the reflector 3 can be a parabolic surface or formed by multiple of curved surfaces.

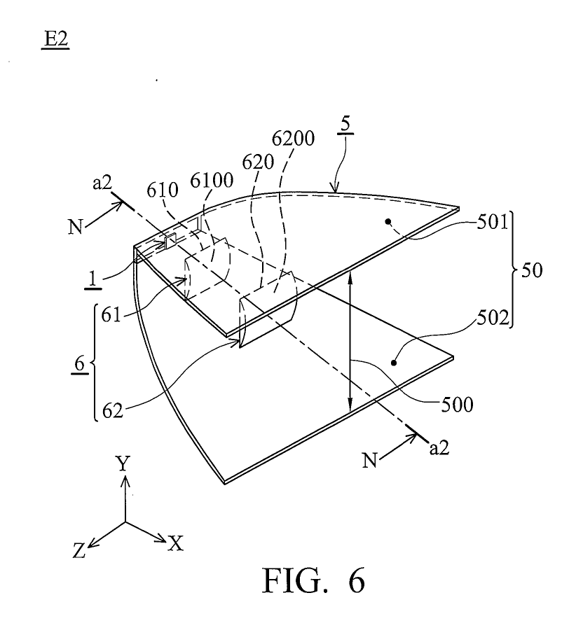

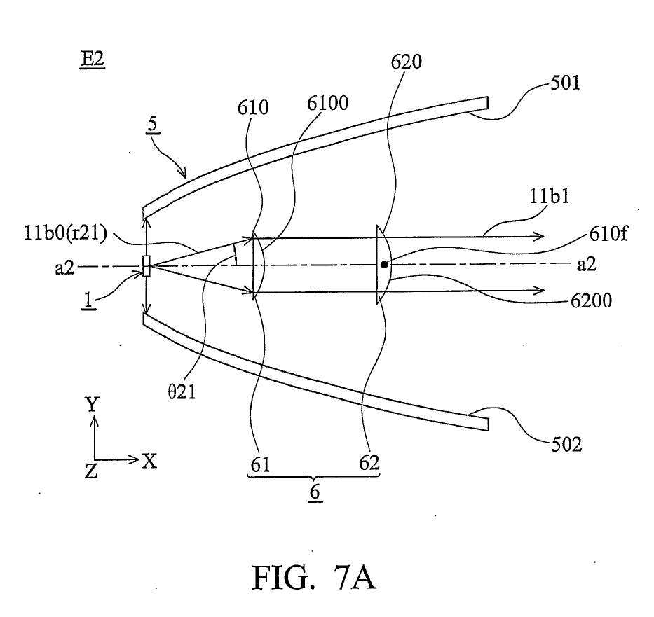

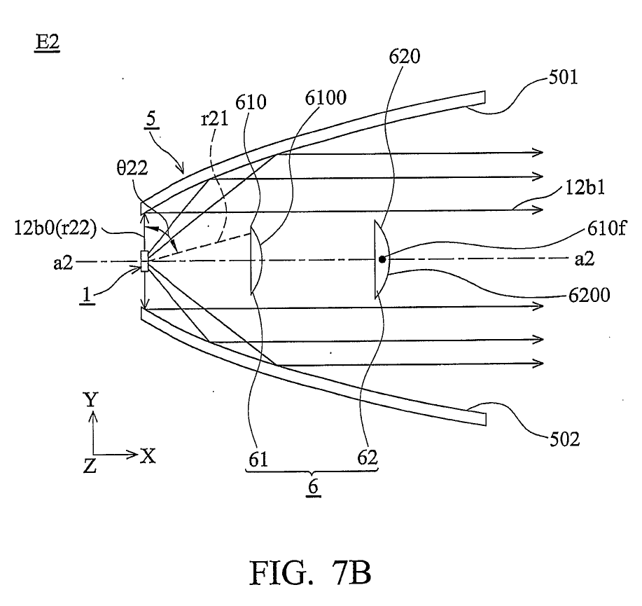

In FIG. 6, a projection illumination device E2 of a second embodiment of the invention comprises the light source 1, a reflector 5 and a lens assembly 6. FIGS. 7A and 7B are two sectional views along an axis a2-a2 and a direction N-N of FIG. 6, respectively specifying two main parts of the light paths of the projection illumination device E2. The geometrical structure of projection illumination device E2 is defined by a three-dimensional, or XYZ, Cartesian coordinate system comprising three axes X, Y and Z. The axis a2-a2 is parallel to the axis X.

The light source 1 and the lens assembly 6 disposed in the reflector 5 along the axis a2-a2 are spaced from each other.

The reflector 5 comprises a reflective surface 50 having a first reflecting region 501 and a second reflecting region 502 and a light-emitting opening 500 formed on the edges of the first and second reflecting regions 501 and 502. The second reflecting region 502 is not connected to the first reflecting region 501, i.e., the reflector 5 is a device comprising a semi-opened structure. The shape of the light-emitting opening 500 is dependent on a curvature of the reflective surface 50.

A plurality of initial light beams 11b0 and 12b0 generated from the light source 1 are guided by the reflector 5 and/or the lens assembly 6 to form a desired projecting mode, e.g. distant-light mode, except the initial light beams traveling along the axis Z. That is to say, the initial light beams traveling along the axis Z are directly emitted toward the remote. In this embodiment, the first and second reflecting regions 501 and 502 are cylindrical curved surfaces, and the two axes of the first and second reflecting regions 501 and 502 are formed by the parabolic lenses having the same curvature, thus, symmetrical light-emitting opening 500 is obtained. Conversely, if the two axes of the first and second reflecting regions 501 and 502 are formed by the parabolic lenses having two distinct curvatures, the profile of the light-emitting opening of the reflector 5 is asymmetrical (not shown in Figs.).

The lens assembly 6 comprises a first lens unit 61 having a first focus 601f and a second lens unit 62 substantially located at the first focus 601f of the first lens unit 61. The first and second lens unit 61 and 62 are disposed apart from each other on the axis a2-a2, and the first lens unit 61 is disposed between the light source 1 and the second lens unit 62. The first lens unit 61 comprises a first cylindrical lens 6100 and the second lens unit 62 comprises a second cylindrical lens 6200. The first and second cylindrical lenses 6100 and 6200 of the first and second lens units 61 and 62 sequentially guide the initial light beams 11b0 of the light source 1 to form a first predetermined light beam 11b1 traveling toward the remote.

With respect to an effective area of the first lens unit 61, conical initial light beams 11b0 of the light source 1 received by the first lens unit 61 are guided to the second lens unit 62. The outer conical surface of the conical initial light beams 11b0 is defined as a first position r21, and a first angle θ21 is substantially formed between the first position r21 and the axis a2-a2. The initial light beams 11b0 located on the first position r21 are defined as a first reference light beam 11b0(r21) traveling along the first position r21. That is to say, the first angle θ21 is a first boundary effective angle θn1 for the lens assembly 2 capable of guiding the initial light beams 11b0 of the light source 1 with respect to the axis a2-a2.

The initial light beams 11b0 located inside the first position r21 and the first reference light beam 11b0(r21) located on the first position r21, i.e., the initial light beams 11b0 located in the range of the first angle θ21 with respect to the axis a2-a2, are converted into a plurality of refracted light beams 11b01 by the first lens unit 61, and the refracted light beams 11b01 guided by the second lens unit 62 forms the first predetermined light beam 11b1 traveling away from the light source 1.

In FIG. 7B, to specify the distribution of the light beams reflected by the reflective surface 50 of the reflector 5, the initial light beams 11b0 located within the first position r21 guided by the first and second lens 61 and 62 of the lens assembly 6 and the first predetermined light beam 11b1 formed by the first and second lens 61 and 62 are omitted.

The initial light beams 12b0 of the light source 1 perpendicular to the axis a2-a2 is reflected by the reflective surface 50 of the reflector 5 to form a second predetermined light beam 12b1 traveling away from the light source 1. The second predetermined light beam 12b1 substantially has a round structure defined as a second position r22, and a second angle θ22 is substantially formed between the second position r22 and the first position r21. The initial light beams 12b0 located on the second position r22 are defined as a second reference light beam 12b0(r22) traveling along the first position r22. In this embodiment, the first angle θ21 is less than or equal to the second angle θ22, and the sum of the first angle θ21 and the second angle θ22 is substantially equal to 90 degrees. The second reference light beam 12b0(r22) has an initial direction substantially perpendicular to the axis a2-a2.

The second angle θ22 is a second boundary effective angle θn2 for the reflective surface 50 of the reflector 5 capable of guiding the initial light beams 12a0 of the light source 1 not passing through lens assembly 6 with respect to the axis a2-a2. The first angle θ21 is less than or equal to 45 degrees or ranging from about 0 to 30 degrees. The second angle θ22 is less than 90 degrees or ranging from about 20 to 90 degrees.

Note that the first and second outer ends 610 and 620 of the lens assembly 6 do not interfere with the second reference light beam 12b0(r22) traveling along the second position r22. That is to say, the structure of the first and second lens units 61 and 62 of the lens assembly 6 is limited within the light paths formed by the second reference light beam 12b0(r22).

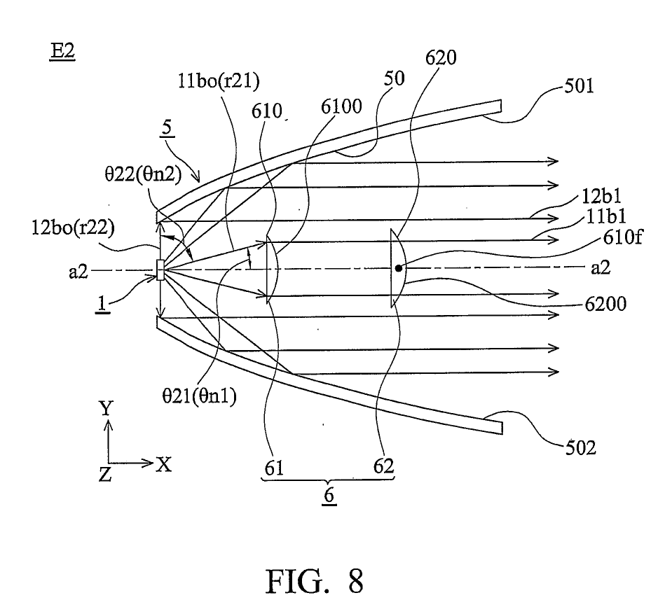

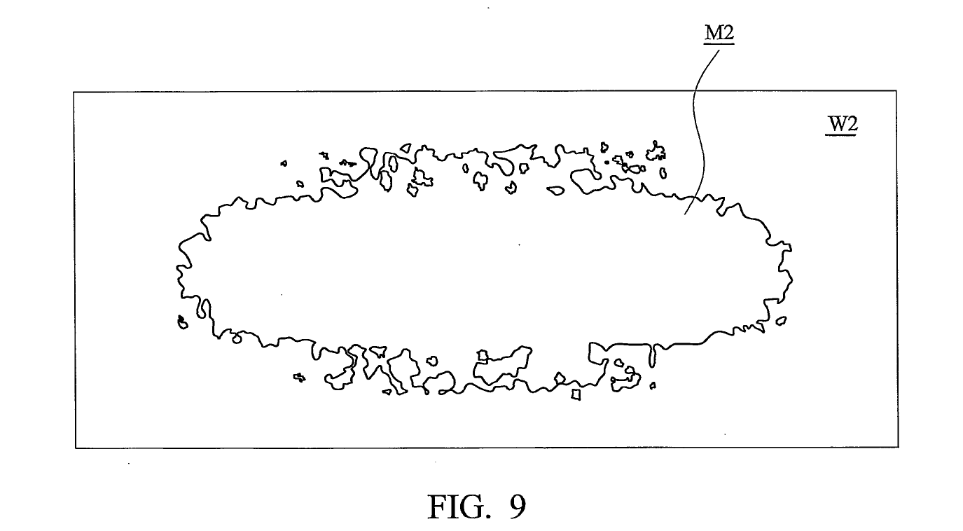

In FIG. 8, the initial light beams 11b0 and 12b0 generated from the light source 1 are guided by the lens assembly 6 and the reflector 5 to form a desired projecting mode M2 (shown in FIG. 9) at a desired distance in front of the projection illumination device E2 according to the related regulations. In this embodiment, the projecting mode M2 is a signal-light mode or signal formed on a plane W2, at a predetermined distance, e.g., 25 meters, away from the projection illumination device E2.

In addition, the connecting portion 4 can be disposed between the reflector 5 and the lens assembly 6 (not shown in Figs.).

In other embodiments, the first and second lens units 61 and 62 of the lens assembly 6 are spherical or non-spherical lenses, and the reflective surface 50 of the reflector 5 can be a cylindrical surface having a parabolic or other curvature.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. (canceled)

2. The projection illumination device as claimed in claim 23, wherein the first angle is a first boundary effective angle for the lens assembly to guide the initial light beams of the light source with respect to the axis.

3. The projection illumination device as claimed in claim 23, wherein the second angle is a second boundary effective angle for the reflective surface of the reflector to guide the initial light beams of the light source not passing through lens assembly with respect to the axis.

4-6. (canceled)

7. The projection illumination device as claimed in claim 23, wherein the reflective surface comprises a parabolic surface.

8. The projection illumination device as claimed in claim 23, wherein the reflective surface of the reflector comprises a main focus, and the light source is located at the main focus.

9. The projection illumination device as claimed in claim 23, wherein the lens assembly comprises a first lens unit and a second lens unit together to guide the initial light beams of the light source, and the first lens unit is located between the light source and the second lens unit.

10. The projection illumination device as claimed in claim 9, wherein the first lens unit comprises a first cylindrical lens and the second lens unit comprises a second cylindrical lens, and the first cylindrical lens and the second cylindrical lens guiding the initial light beams of the light source.

11. The projection illumination device as claimed in claim 23, wherein the lens assembly comprises a first lens unit having a first focus and a second lens unit substantially located at the first focus, and the first lens unit and the second lens unit sequentially guide the initial light beams of the light source.

12. The projection illumination device as claimed in claim 23, wherein the first angle is less than or equal to 45 degrees.

13. The projection illumination device as claimed in claim 23, wherein the first angle ranges from 0 to 30 degrees.

14-15. (canceled)

16. The projection illumination device as claimed in claim 23 further comprising at least one connecting portion disposed between the lens assembly and the reflector.

17. The projection illumination device as claimed in claim 23, wherein the reflective surface comprises a first reflecting region and a second reflecting region being not connected to the first reflecting region.

18. The projection illumination device as claimed in claim 17, wherein the first reflecting region comprises a cylindrical curved surface.

19. The projection illumination device as claimed in claim 17, wherein the second reflecting region comprises a cylindrical curved surface.

20. The projection illumination device as claimed in claim 23, wherein the projecting mode comprises an indicator mode or a signal light mode.

21. The projection illumination device as claimed in claim 23, wherein the initial light beams, the first reference light beam and the second reference light beam substantially travel along the same direction.

22. The projection illumination device as claimed in claim 23, wherein the reflector further comprises a light-emitting opening, and the shape of the light-emitting opening is dependent on a curvature of the reflector.

23. A projection illumination device, comprising:
a light source disposed on an axis, generating a plurality of initial light beams ranged from the axis up to and including an effective position, wherein the effective position is perpendicular to the axis;
a lens assembly disposed on the axis and comprising an outer end, the lens assembly arranged to guide the initial light beams within a first angle ranged from the axis to the outer end with respect to the light source, to form a first predetermined light beam traveling away from the light source; and
a reflector comprising a reflective surface, the reflector arranged to guide the initial light beams within a second angle ranged from the outer end of the lens assembly up to and including the effective position with respect to the light source, to form a second predetermined light beam traveling away from the light source, wherein the second predetermined light beam encloses the lens assembly without impinging thereon.

24. The projection illumination device as claimed in claim 23, wherein the sum of the first angle and the second angle is substantially equal to 90 degrees.

25. A projection illumination device, comprising:
a light source disposed on an axis;
a lens assembly disposed on the axis; and
a reflector comprising a reflective surface disposed on the axis, the light source, lens assembly and reflector arranged such that initial light beams radiating from the light source within a first boundary are incident to the lens assembly without being subject to reflection by the reflector to become refracted light beams traveling parallel to the axis, and initial light beams radiating from the light source outside the first boundary are reflected by the reflector to become reflected light beams traveling parallel to the axis, wherein the reflected light beams do not impinge upon the lens assembly.

26. The projection illumination device of claim 25, wherein the light source, lens assembly and reflector are arranged such that the lens assembly is encompassed by reflected light beams reflected from initial lights beams radiated in a direction perpendicular to the axis.

27. The projection illumination device of claim 25, wherein the light source, lens assembly and reflector are arranged such that the light source radiates initial light beams within a second boundary up to and including a direction perpendicular to the axis, and the reflected light beams originate from initial lights beams radiated outside the first boundary and within the second boundary.
